(19) United States
(12) Patent Application Publication
(10) Pub. No.: US 2022/0321970 A1
(43) Pub. Date: Oct. 6, 2022

(54) Dynamic Real-Time Audio-Visual Search Result Assembly

(71) Applicant: VOODLE, INC., Seattle, WA (US)

(72) Inventors: Mike Swanson, Sammamish, WA (US); Forest Key, Arroyo Grande, CA (US); Beverly Sum Vessella, Seattle, WA (US)

(21) Appl. No.: 17/685,309

(22) Filed: Mar. 2, 2022

Related U.S. Application Data
(60) Provisional application No. 63/156,271, filed on Mar. 3, 2021.

(51) Int. Cl. H04N 21/472; G06V 20/40; H04N 19/40; G11B 27/34; H04N 21/482

(52) U.S. Cl. CPC H04N 21/47217; G06V 20/49; H04N 19/40; G06V 20/46; G11B 27/34; H04N 21/482

(57) ABSTRACT

Systems and methods are disclosed to more efficiently and effectively search for videos. A video sharing system may receive a video from a user, may extract features from the received video and may store the extract features for the video. Moreover, based on a prespecified re-encoding scheme, the video sharing system re-encodes the received video. For example, the video re-encoding may be performed by generating a set of video segments from video data of the received video such that each video segment is independently playable by a media player. The video sharing platform then stores the re-encoded video including information for each video segment of the set of video segments generated during the re-encoding process of the received video. The re-encoded videos can then be used, in real-time, to dynamically generate search result videos that includes snipes from multiple videos that match a given search query.

### CROSS REFERENCE TO RELATED APPLICATIONS

This application claims the benefit of U.S. Provisional Application No. 63/156,271, filed Mar. 3, 2021, which is incorporated by reference in its entirety.

### BACKGROUND

### 1. Field of Art

The disclosure generally relates to the field of video encoding and more specifically to real-time generation of a search result video including snippets from multiple videos.

### 2. Description of the Related Art

Video sharing platforms allow content providing users to upload videos and allow viewing users to consume the uploaded videos. As the amount of content that is available in a video sharing platform increases it becomes advantageous for the video sharing platform to implement a mechanism to filter and sort the videos, and to search through the videos to enable users to land on content that is of interest to them.

Video sharing platforms may provide a list of videos in response to search queries provided by viewing users seeking to consume content in the video sharing platform. The video sharing platform may then allow the viewing user to access one or more of the videos included in the list of videos (e.g., by accessing a link corresponding to the video). However, using this searching scheme, users are unable to determine which video matches what the viewing user is trying find without accessing the video and watching at least a portion of the video. Moreover, even if the user accesses the video and watches a portion of the video, this searching scheme does not provide any guidance to the viewing user as to which portion of the video matches what the viewing user is searching for. As such, the user may waste a significant amount of time accessing videos that are irrelevant to what the user is trying to find. Thus, there is a need for an improved way to present video search results to viewing users trying to consume specific video content in an online system.

### SUMMARY

Embodiments relate to a video sharing system that enables users to more efficiently and effectively search for videos. To enable the improved video searching scheme, the video sharing system re-encodes received videos to be able to generate highlight reels in response to a search query. In particular, the video sharing system may receive a video from a user of the video sharing system, may extract features from the received video and may store the extracted features for the video. Moreover, based on a prespecified re-encoding scheme, the video sharing system re-encodes the received video. For example, the video re-encoding may be performed by generating a set of video segments from video data of the received video such that each video segment is independently playable by a media player. The video sharing platform then stores the re-encoded video including information for each video segment of the set of video segments generated during the re-encoding process of the received video.

In another aspect of the video sharing system, the video sharing system may receive a search query from a user of the video sharing system. The video sharing system identifies a set of search results based on the received search query. Each search result may identify a video and a timestamp and duration within the video. Moreover, for each search result of the identified set of search results, one or more video snippets are identified. The video sharing system then generates a search result video by combining the identified set of video snippets.

In yet another aspect of the video sharing system, the video sharing system presents search result videos to users of the video sharing system. In particular, search result videos presented to viewing users of the video sharing system includes a set of video snippets, each video snippet corresponding to a search result for a search query provided by the viewing user. Moreover, the video sharing system may receive a request to access a video associated with a video snippet from the set of video snippets that is currently being played by a media player of the client device of the viewing user. In response to receiving the request, the video sharing system determines a video associated with the video snippet based on the playback time of the search result video when the request was received, and presents the identified video to the viewing user.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is an overview diagram of a video sharing system, according to one or more embodiments.

FIG. 2A is a block diagram of a system environment in which an online system (such as a video sharing system) operates, according to one or more embodiments.

FIG. 2B is a block diagram of an architecture of the online system, according to one or more embodiments.

FIG. 3 is a system environment diagram for the intake of video by the intake module 260, according to one or more embodiments.

FIG. 4 is a block diagram of the components of the intake module, according to one or more embodiments.

FIG. 5 is a flow diagram of a process for intaking videos, according to one or more embodiments.

FIG. 6 is a system environment diagram for providing search results to viewing users, according to one or more embodiments.

FIG. 7 is a block diagram of the components of the search module, according to one or more embodiments.

FIG. 8 illustrates a diagram identifying a video fragment and a video snippet, according to one or more embodiments.

FIG. 9 illustrates a set of manifest files for a search result video, according to one or more embodiments.

FIG. 10 is a flow diagram of a process for providing search results to a viewing user, according to one or more embodiments.

FIG. 11 is a system environment diagram for playing a search result video, according to one or more embodiments.

FIG. 12 is a block diagram of the components of the playback module, according to one or more embodiments.

FIG. 13 is a flow diagram of a process for providing search results and playing a search result video, according to one or more embodiments.

FIG. 14 is a block diagram illustrating components of an example machine able to read instructions from a machine-readable medium and execute them in a processor (or controller), according to one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

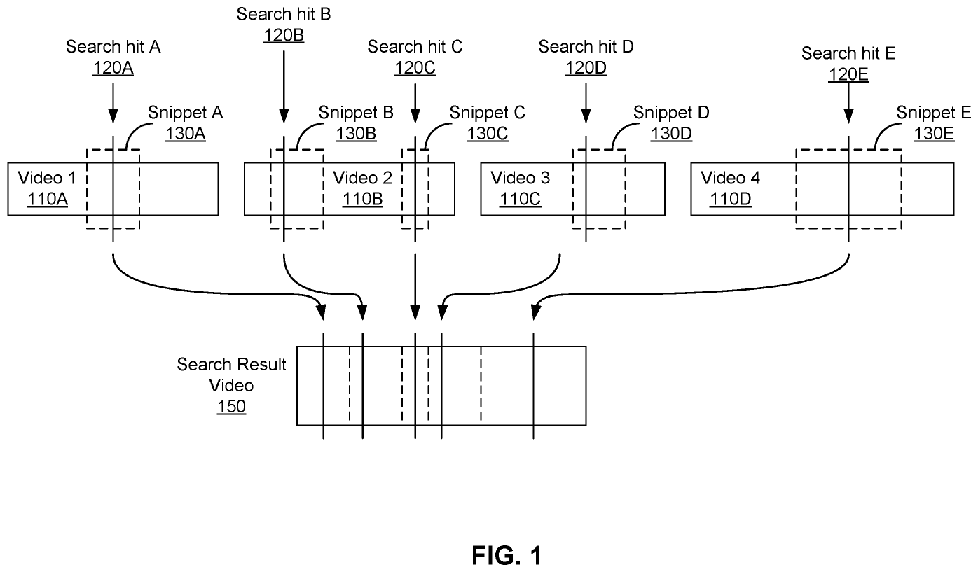

FIG. 1 is an overview diagram of a video sharing system, according to one or more embodiments. Users of the video sharing system can search for videos that are being provided by the video sharing system. The users may provide a search query (e.g., by specifying one or more search terms, specifying a sorting scheme, and/or specifying a filtering criteria). The video sharing system identifies one or more videos that are relevant to the search query and presents the videos to the user. The video sharing system presents a search result video that includes snippets from each video that is identified by the video sharing system as being relevant to the search query. The user is able to play the search result video instead of having to manually access each video identified by the video sharing system as being relevant to the search query. This may increase the efficiency of users in finding the videos that the user was searching for.

Although the following description is provided using a video sharing system as an example, the techniques described herein may also be applied to other types of media content sharing systems. For example, various features of the video sharing system can also apply to audio sharing platforms such as podcast hosting platforms that provide searching capabilities. The media content sharing system may identify one or more audio streams (e.g., audio files or audio data embedded in videos) that are relevant to a search query and presents a search result audio stream that includes snippets from each audio stream identified by the media content sharing system as being relevant to the search query.

In the example of FIG. 1, the video sharing system identifies at least 4 videos 110A-110D as being relevant to a search query. For example, the video sharing system identifies search hit A 120A within video 1 110A, search hit B 120B and search hit C 120C within video 2 110B, search hit D 120D within video 3 110C, and search hit E 120E within video 4 110D as being relevant to the search query. Based on the search results, the video sharing system identifies snippet A 130A from video 1 110A, snippet B 130B and snippet C 130C from video 2 110B, snippet D 130D from video 3 110C, and snippet E 130E from video 4 110D as being relevant to the search query. The video sharing system then combines the identified snippets into a search result video 150 and transmits the search result video to the user that provided the search query.

### System Architecture

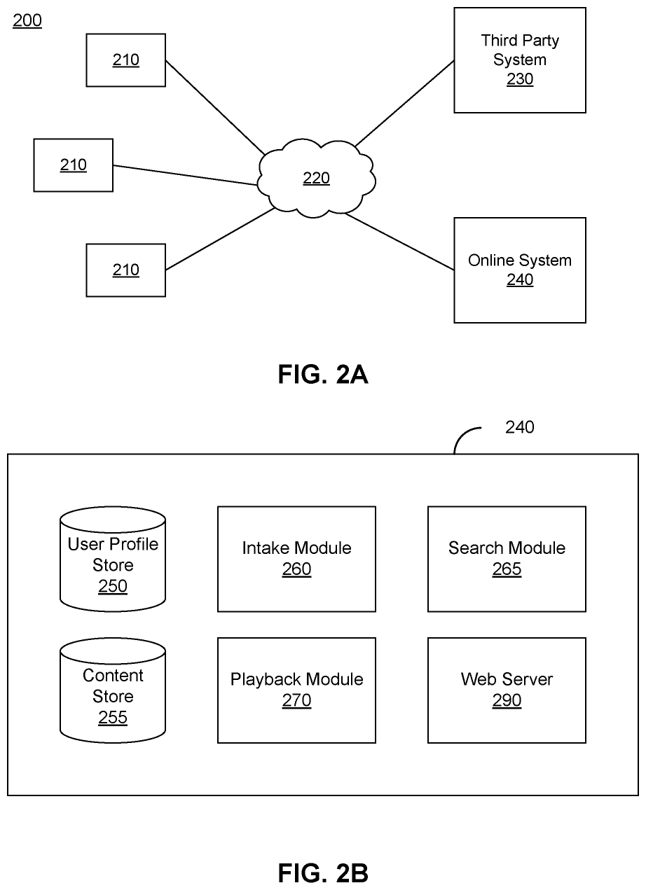

FIG. 2A is a block diagram of a system environment 200 for an online system 240, according to one or more embodiments. The system environment 200 shown by FIG. 2 comprises one or more client devices 210, a network 220, one or more third-party systems 230, and the online system 240. In alternative configurations, different and/or additional components may be included in the system environment 200. For example, the online system 240 is a video sharing system for providing videos created by one or more content creators to viewing users.

The client devices 210 are one or more computing devices capable of receiving user input as well as transmitting and/or receiving data via the network 220. In one embodiment, a client device 210 is a conventional computer system, such as a desktop or a laptop computer. Alternatively, a client device 210 may be a device having computer functionality, such as a personal digital assistant (PDA), a mobile telephone, a smartphone, or another suitable device. A client device 210 is configured to communicate via the network 220. In one embodiment, a client device 210 executes an application allowing a user of the client device 210 to interact with the online system 240. For example, a client device 210 executes a browser application to enable interaction between the client device 210 and the online system 240 via the network 220. In another embodiment, a client device 210 interacts with the online system 240 through an application programming interface (API) running on a native operating system of the client device 210, such as IOS® or ANDROID™.

The client devices 210 are configured to communicate via the network 220, which may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

One or more third party systems 230 may be coupled to the network 220 for communicating with the online system 240. In one embodiment, a third-party system 230 is an application provider communicating information describing applications for execution by a client device 210 or communicating data to client devices 210 for use by an application executing on the client device. In other embodiments, a third-party system 230 provides content or other information for presentation via a client device 210. A third-party system 230 may also communicate information to the online system 240, such as advertisements, content, or information about an application provided by the third-party system 230.

FIG. 2B is a block diagram of an architecture of the online system 240, according to one or more embodiments. The online system 240 shown in FIG. 2B includes a user profile store 250, a content store 255, an intake module 260, a search module 265, a playback module 270, and a web server 290. In other embodiments, the online system 240 may include additional, fewer, or different components for various applications. Conventional components such as network interfaces, security functions, load balancers, failover servers, management and network operations consoles, and the like are not shown so as to not obscure the details of the system architecture.

Each user of the online system 240 is associated with a user profile, which is stored in the user profile store 250. A user profile includes declarative information about the user that was explicitly shared by the user and may also include profile information inferred by the online system 240. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user.

While user profiles in the user profile store 250 are frequently associated with individuals, allowing individuals to interact with each other via the online system 240, user profiles may also be stored for entities such as businesses or organizations. This allows an entity to establish a presence on the online system 240 for connecting and exchanging content with other online system users. The entity may post information about itself, about its products or provide other information to users of the online system 240 using a brand page associated with the entity's user profile. Other users of the online system 240 may connect to the brand page to receive information posted to the brand page or to receive information from the brand page. A user profile associated with the brand page may include information about the entity itself, providing users with background or informational data about the entity.

The content store 255 stores objects that each represent various types of content. Examples of content represented by an object include a page post, a status update, a photograph, a video, a link, a shared content item, or any other type of content. Online system users may create objects stored by the content store 255. For instance, users may record videos and upload them to the online system 240 to be stored in the content store 255. In some embodiments, objects are received from third-party applications or third-party applications separate from the online system 240. In one embodiment, objects in the content store 255 represent single pieces of content, or content “items.” Hence, online system users are encouraged to communicate with each other by posting text and content items of various types of media to the online system 240 through various communication channels. This increases the amount of interaction of users with each other and increases the frequency with which users interact within the online system 240.

In some embodiments, the online system 240 allows users to upload content items created outside of the online system 240. For example, a user may record and edit a video using a third-party system (e.g., using a native camera application of a mobile device), and upload the video to the online system 240. In other embodiments, the online system 240 provides the user tools for creating content items. For example, the online system 240 provides a user interface that allows the user to access a camera of a mobile device to record a video. In this embodiment, the online system 240 may control certain parameters for creating the content item. For example, the online system 240 may restrict the maximum length of a video, or a minimum resolution for the captured video.

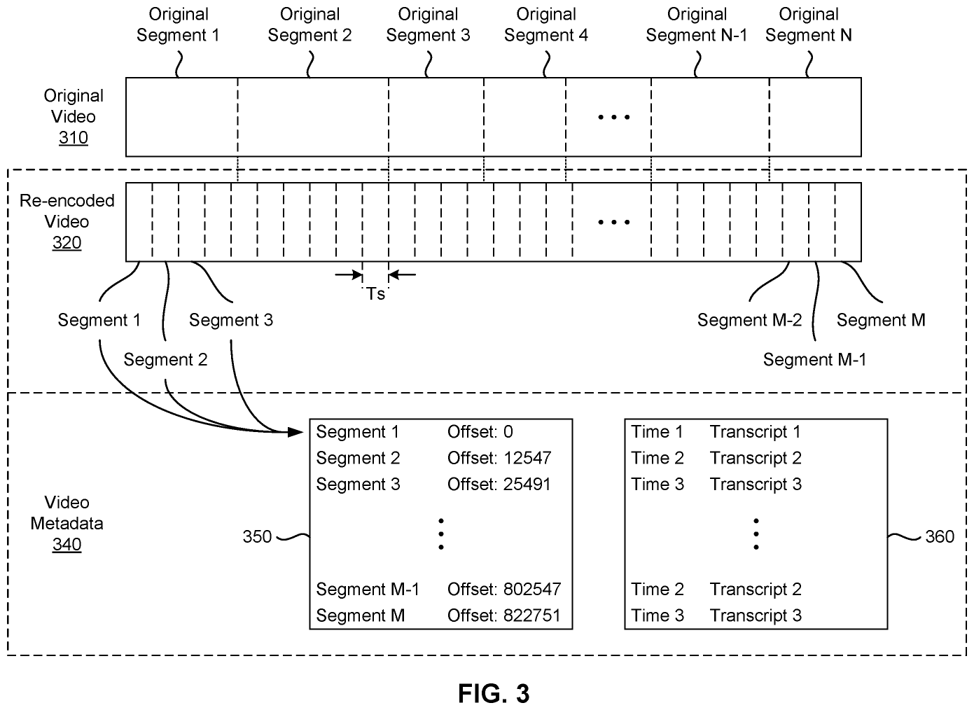

The intake module 260 receives content items created by users of the online system 240 and processes the content items before they are stored in the content store 255. For instance, the intake module 260 modifies the received content items based on a set of parameters. Moreover, the intake module 260 analyzes the received content items and generates metadata for the received content items. The metadata for the content items can then be used for selecting content to present to viewing users. For example, the metadata can be used for selecting content items in response to a search query provided by a viewing user. The intake module 260 is described in more detail below in conjunction with FIGS. 3-5.

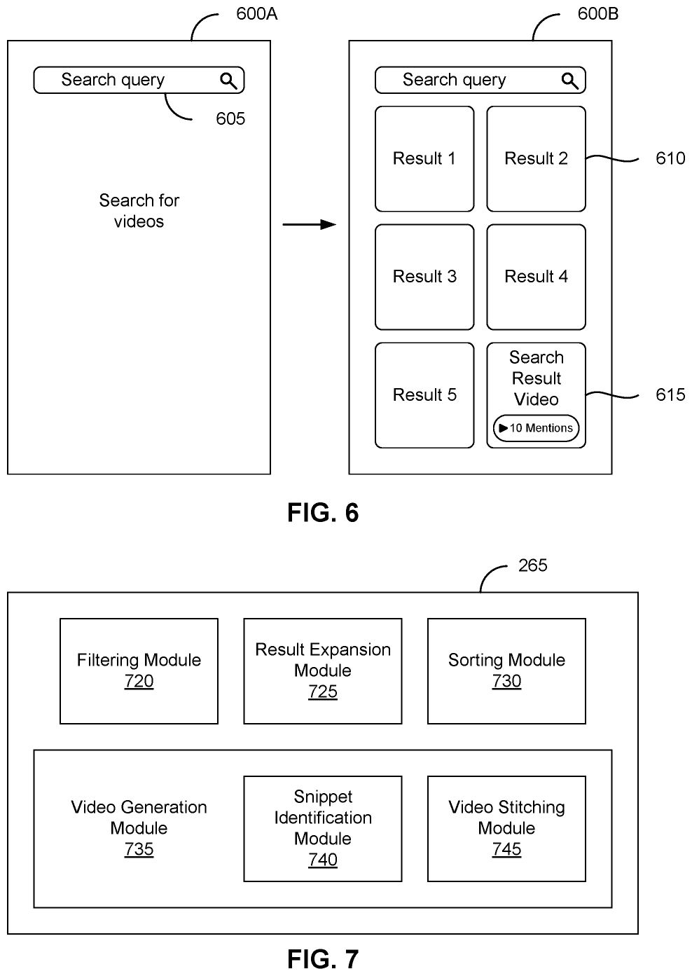

The search module 265 receives search queries from users and provides search results corresponding to the received search queries. In some embodiments, the search module 265 identifies content items stored in the content store 255 matching the search query and provides the search results to a viewing user. In some embodiments, the search module 265 generates a new content item using portions of the content items identified as matching the search query and provides the new content item to the viewing user. For example, for video content, the search module 265 generates a search result video by combining portions of multiple videos that matched a search query. The search module 265 is described in more detail below in conjunction with FIGS. 6-10.

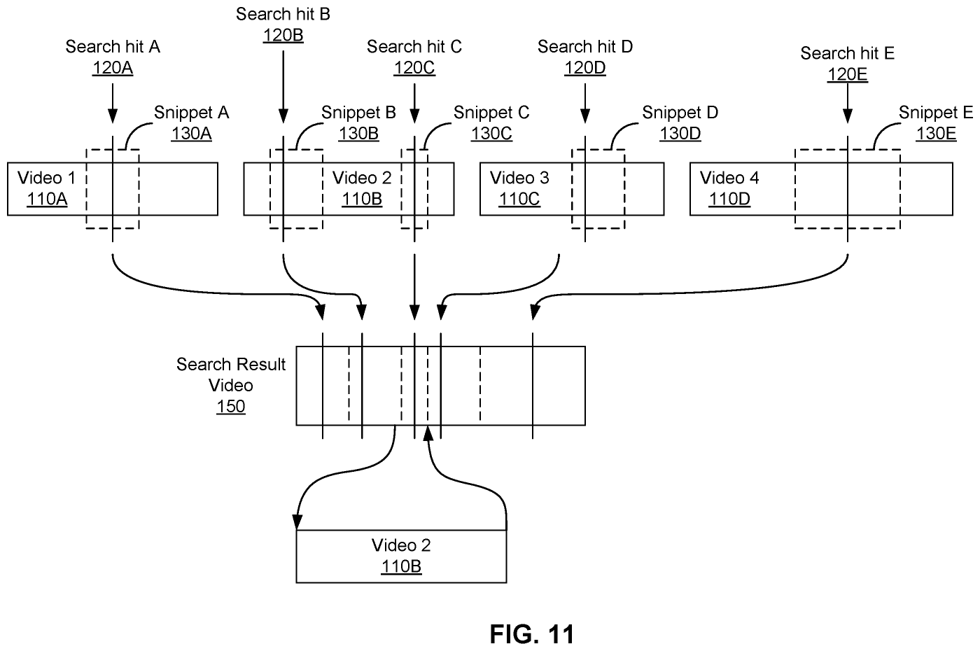

The playback module 270 provides an interface to present content items to viewing users. The playback module 270 retrieves content items stored in the content store 255, decodes the content items and presents the decoded content items to the viewing users. The playback module 270 is described in more detail below in conjunction with FIGS. 11-13.

The web server 290 links the online system 240 via the network 220 to the one or more client devices 210, as well as to the one or more third party systems 230. The web server 290 serves web pages, as well as other content, such as JAVA®, FLASH®, XML and so forth. The web server 290 may receive and route messages between the online system 240 and the client device 210, for example, instant messages, queued messages (e.g., email), text messages, short message service (SMS) messages, or messages sent using any other suitable messaging technique. A user may send a request to the web server 290 to upload information (e.g., images or videos) that are stored in the content store 255. Additionally, the web server 290 may provide application programming interface (API) functionality to send data directly to native client device operating systems, such as IOS®, ANDROID™, or BlackberryOS.

### Video Intake

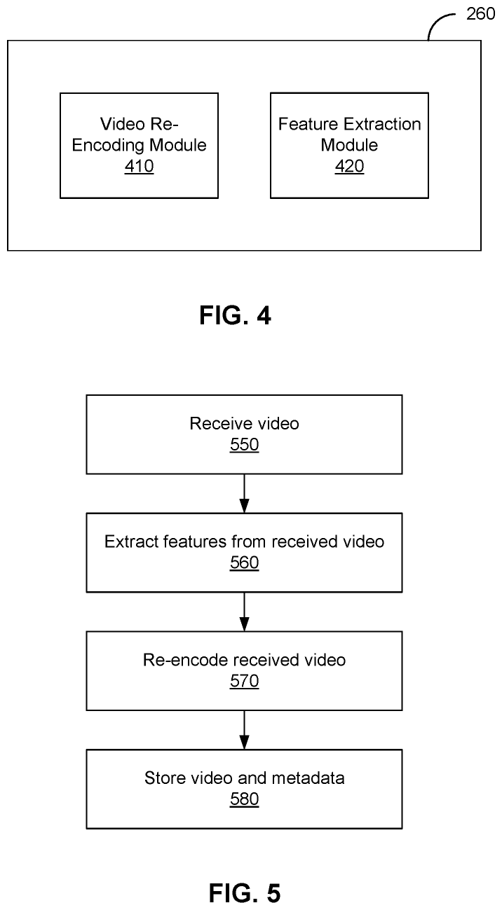

The intake module 260 receives content items created by users of the online system 240 and processes the content items before they are stored in the content store 255. FIG. 3 is a system environment diagram for the intake of video by the intake module 260, according to one or more embodiments. FIG. 4 is a block diagram of the components of the intake module 260, according to one or more embodiments. The intake module 260 includes the video re-encoding module 410, and the feature extraction module 420.

The video re-encoding module 410 re-encodes the videos received by the online system based on a set of parameters. To re-encode a video, the video re-encoding module 410 divides the video into segments having a predetermined length (e.g., half a second). The video re-encoding module then encodes the video in a way so that each segment is able to be played independently from each other. For example, for every segment of the video, the video re-encoding module 410 generates a keyframe for the first frame of the segment and encodes the subsequent frames (in-between frames) of the segment based on the generated keyframe. For example, the second frame of the segment is encoded based on the difference between the first frame of the segment and the second frame of the segment. Similarly, the third frame of the segment is encoded based on the difference between the first frame of the segment and the third frame of the segment. Alternatively, the third frame is encoded based on the difference between the second frame of the segment and the third frame of the segment.

In other embodiments, the video re-encoding module 410 divides the video into segments having varying lengths. In one embodiment, the re-encoding module 410 identifies scene changes in the video. For example, the re-encoding module 410 identifies when the difference between one frame and a next frame is larger than a threshold. In this embodiment, the re-encoding module 410 additionally adds a keyframe at the beginning of the new scene. That is, the re-encoding module 410 creates a new segment starting at the identified scene change.

In the example of FIG. 3, the original video 310 (e.g., the video provided by a user of the online system 240) includes N segments (original segment 1 through original segment N). In the example of FIG. 3, each segment in the original video 310 has a different length. However, in some embodiments, one or more segments in the original video 310 have the same length.

The original video 310 is re-encoded to a video having M segments. Each segment in the re-encoded video 320 has a length Ts. To re-encode the video, the re-encoding module 410 generates a keyframe for each segment. In some embodiments, the re-encoded video 320 starts processing the original video 310 from the start. As the original video 310 is read, the re-encoding module 410 determines whether a current frame being processed corresponds to a keyframe in the re-encoded video 320. If the re-encoding module 410 determines that the current frame corresponds to a keyframe in the re-encoded video 320, the keyframe is generated based on the data that has already been read from the original video 310. Alternatively, if the re-encoding module 410 determines that the current frame does not correspond to a keyframe in the re-encoded video 320, the re-encoding module 410 generates an in-between frame based on the data that has already been read form the original video 310 and at least one of the previous keyframe generated for the re-encoded video 320 (i.e., the keyframe for the current video segment in the re-encoded video 320) or the last in-between frame generated for the re-encoded video 320 (i.e., the frame immediately preceding the current frame being processed).

In other embodiments, for each segment in the re-encoded video 320, the re-encoding module 410 identifies one or more segments from the original video 310 that overlaps with the segment. The re-encoding module 410 then calculates the video data for the first frame of the segment in the re-encoded video 320. For example, the keyframe for segment 1 of the re-encoded video 320 is determined from the video data of the original segment 1 of the original video 310. Similarly, the keyframe for segment 2 of the re-encoded video 320 is determined from the video data of the original segment 1. Moreover, the keyframe for segment M of the re-encoded video 320 is determined from the video data of the original segment N of the original video 310. Moreover, for each frame of each segment in the re-encoded video 320 other than the keyframe, the re-encoding module 410 calculates video data based on the keyframe of the segment and video data of the original segments that overlap with the segment.

The re-encoding module 410 generates metadata 340 for the re-encoded video 320. In some embodiments, the re-encoding module 410 generates segment metadata 350 identifying each segment in the re-encoded video 320. For each segment in the re-encoded video 320, the segment metadata 350 may include a start time (e.g., in seconds or milliseconds), and an offset (in bits or bytes) from the beginning of the video file.

The feature extraction module 420 analyzes the videos received by the online system to extract one or more features. For example, the feature extraction module 420 generates a transcript 360 of videos received by the online system. The transcript 360 may include one or more words spoken in the video and a timestamp associated with the one or more words. Moreover, the transcript 360 may include an identification of a person saying the one or more words in the video. In another example, the feature extraction module 420 applies one or more object recognition models to identify one or more objects or persons that appear in a video. The feature extraction module 420 then generates metadata identifying the object or persons that appear in the video and a timestamp associated with the objects or persons. Other examples of features include sentiment, logo recognition, signage character recognition, conversational topics, etc.

FIG. 5 is a flow diagram of a process for intaking videos, according to one or more embodiments. The intake module 240 receives 550 a new video to be stored in the content store 255. The feature extraction module 420 extracts 560 features from the received video. The extracted features are associated with timestamps identifying a temporal location within the received video where the feature was extracted from. For example, features extracted include a transcript. The transcript includes a set of words, each associated with a timestamp and duration corresponding to the temporal location within the view when the words are heard in an audio track of the video.

The video re-encoding module 410 re-encodes 570 the received video. The video re-encoding module 410 re-encodes the received videos based on a set of re-encoding parameters (e.g., indicating a pre-determined segment length, a pre-determined bitrate or resolution, a maximum bitrate or resolution, a maximum video length, etc.). Additionally, the video re-encoding module 410 may generate metadata 340 for the re-encoded video 320. For example, the re-encoding module 410 generates metadata 350 identifying each of the new segments in the re-encoded video 320, as well as a bit offset indicating where the data for each of the segments start.

The intake module 260 stores 580 the re-encoded video 320 and the generated metadata 340 in the content store 250. In some embodiments, the intake module 260 additionally stores the original received video 310 together with the re-encoded video 320. In other embodiments, the intake module 260 stores multiple versions of the re-encoded video 320. For example, the intake module 260 may generate multiple re-encoded videos 320, each based on a different set of re-encoding parameters (e.g., having different resolutions), and stores the multiple re-encoded videos 320 in the content store 255.

### Video Search

The search module 265 receives search queries from users and provides search results corresponding to the received search queries. FIG. 6 is a system environment diagram for providing search results to viewing users, according to one or more embodiments. Viewing users provide search queries 605 through a user interface 600A to access videos that are available through the online system 240. In response to a search query, the search module 265 identifies multiple search results 610 and presents the search results to the viewing user through a user interface 600B. Moreover, the search module 265 generates a search result video 615 and presents the search result video to the viewing user through the user interface 600B.

FIG. 7 is a block diagram of the components of the search module 265, according to one or more embodiments. The search module 265 includes the filtering module 720, the result expansion module 725, the sorting module 730, and the video generation module 735. Moreover, the video generation module 735 includes the snippet identification module 740, and a video stitching module 745.

The filtering module 720 identifies one or more videos stored in the content store 255 that match a search query 605. In some embodiments, the filtering module 720 identifies the one or more videos based on the metadata for each of the videos stored in the content store 255. For instance, the filtering module 720 searches for one or more terms included in the search query 605 within the metadata of content items stored in the content store 255.

In some embodiments, the filtering module 720 identifies a set of search results for the search query. Each search result is associated with a video stored in the content store 255, and a timestamp within the video. For example, the filtering module 720 searches, within transcripts of videos stored in the content store 255, for words included in a search query. If the filtering module 720 determines a portion of a video as being relevant to the search query (e.g., by determining that the transcript of the video included one or more words from the search query), the filtering module generates a search result including an identification of the video containing a portion being relevant to the search query, and a timestamp and duration within the video for the portion that is relevant to the search query.

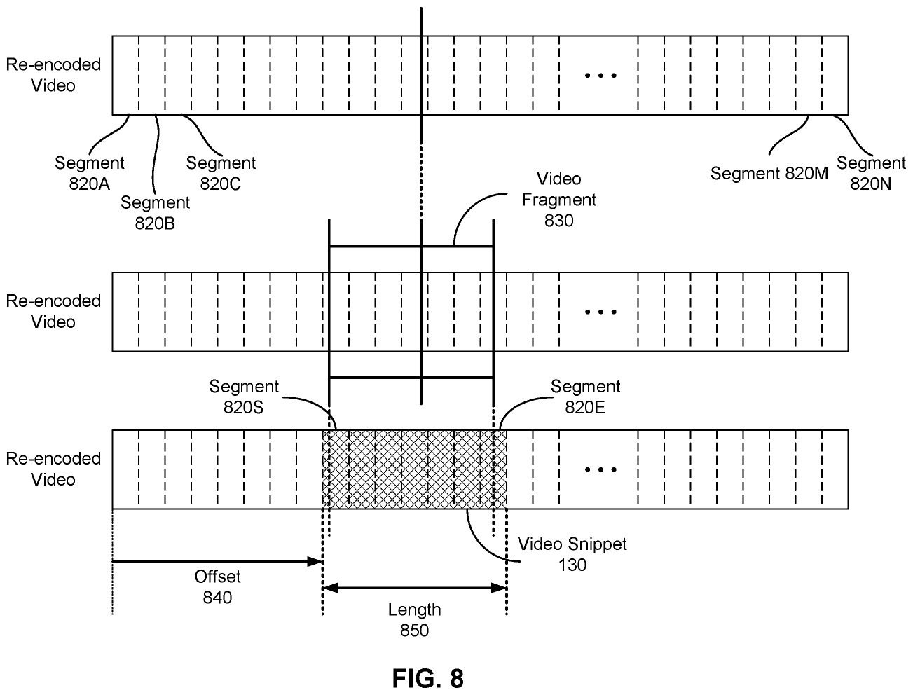

The result expansion module 725 identifies a video fragment that includes a search result. FIG. 8 illustrates a diagram identifying a video fragment 830, according to one or more embodiments. For a search result identifying a video and a timestamp within the video, the result expansion module 725 identifies a start timestamp that is prior to the timestamp identified by the search result, and an end timestamp that is after the timestamp and duration identified by the search result within the video based on metadata for the video.

In some embodiments, the result expansion module 725 identifies a video fragment 830 by identifying a beginning of a sentence and an end of the sentence being spoken in the video identified by the search result that includes the timestamp and duration identified by the search result. For example, the result expansion module 725 identifies a sentence in a transcript of the video based on the timestamp and duration identified by the search result. The result expansion module 725 then identifies, from the transcript, a timestamp for the beginning of the identified sentence and a timestamp for the end of the identified sentence. In another example, the result expansion module 725 identifies boundaries for the fragment 830 based on audio pauses that precedes and follows the timestamp identified by the search result.

In other embodiments, the result expansion module 725 identifies a video fragment 830 by identifying scene changes within the video identified by the search result, or by identifying when certain objects or people appear in the video identified by the search result. For example, the result expansion module 725 identifies the video fragment 830 by identifying the start and end of a scene that includes the timestamp identified by the search result.

The sorting module 730 sorts the search results identified by the filtering module 720. In some embodiments, the sorting module 730 sorts the search results based on their relevancy to the search query. For instance, the sorting module 730 determines a relevancy score based on metadata for a video or video fragment 830 associated with a search result, and details of the search query. For example, the relevancy score for a search result may be determined based on a number of times one or more words from the search query appear within a video fragment 830 associated with the search result.

In some embodiments, the sorting module 730 sorts the search results based on characteristics of the video associated with the search result. For instance, the sorting module 730 determines the relevancy score additionally based on metadata for the video associated with the search result. For example, the sorting module 730 determines the relevancy score based on a length of time since the video associated with the search result was created or uploaded to the online system 240, a number of times the video associated with the search result was viewed by users of the online system 240, a number of distinct users that viewed the video associated with the search result, a number of likes or dislikes of the video associated with the search result, or a number of comments provided by users of the online system for the video associated with the search result.

In other embodiments, the sorting module 730 sorts the search results based on their affinity to the viewing user that provided the search query. For instance, the sorting module 730 determines an affinity score based on metadata for a video associated with a search result and user information (e.g., from a user profile of a viewing user). For example, the affinity score for a search result may be determined based on a similarity between the video or video fragment 830 associated with the search result and other videos the viewing user has interacted with in the past (e.g., other videos the user has viewed, shared, or liked in the past).

In some embodiments, the sorting module 730 sorts the search results based on a combination of factors. For example, the sorting module 730 sorts the search results based on a combination of two or more scores (e.g., a combination of the relevance score and the affinity score). In some embodiments, the sorting module 730 combines scores for multiple search results that are associated with the same video. For example, if a word or phrase included in a search query appears in multiple portions of a video, the filtering module 720 may identify multiple search results associated with the video (e.g., one search result for each portion of the video where the word of phrase included in the search query appears). The sorting module 730 may aggregate the search results associated with the same video and sort the multiple search results associated with the same video together.

The video generation module 735 compiles a search result video using the search results identified by the filtering module 720 and the sorting order provided by the sorting module 730. The video generation module 735 includes the snippet identification module 740, and the video stitching module 745.

The snippet identification module 740 identifies a video snippet 130 for a video fragment 830 to be included in the complied search result video. FIG. 8 illustrates a diagram identifying a video snippet 130, according to one or more embodiments. The snippet identification module 740 identifies a set of video segments that overlap with the video fragment 830 identified by the result expansion module 725. For example, the snippet identification module 740 identifies a video segment 820S from the video identified by a search result associated with a video fragment 830 that contains the start of the video fragment 830. Moreover, the snippet identification module 740 identifies a video segment 820E from the video identified by a search result associated with a video fragment 830 that contains the end of the video fragment 830. Alternatively, the snippet identification module 740 determines an amount of time 850 that is between the start of the video segment 820S that contains the start of the video fragment 830, and the end of the video fragment 830.

In some embodiments, in identifying the video segment 820S that contains the start of the video fragment 830, the snippet identification module 740 determines a byte offset 840 from the metadata of the video identified by the search result associated with the video fragment 830 that corresponds to the start of the video segment 820S that contains the start of the video fragment 830. That is, the snippet identification module 740 identifies the portion of the file storing the video associated with the search result that contains the data for playing the video fragment 830. The determined byte offset 840 identifies the portion of the file storing the video associated with the search result that corresponds to the video segment 820S that contains the start of the video fragment 830. For example, the byte offset 840 identifies the data storing the keyframe for the video segment 820S that contains the start of the video fragment 830.

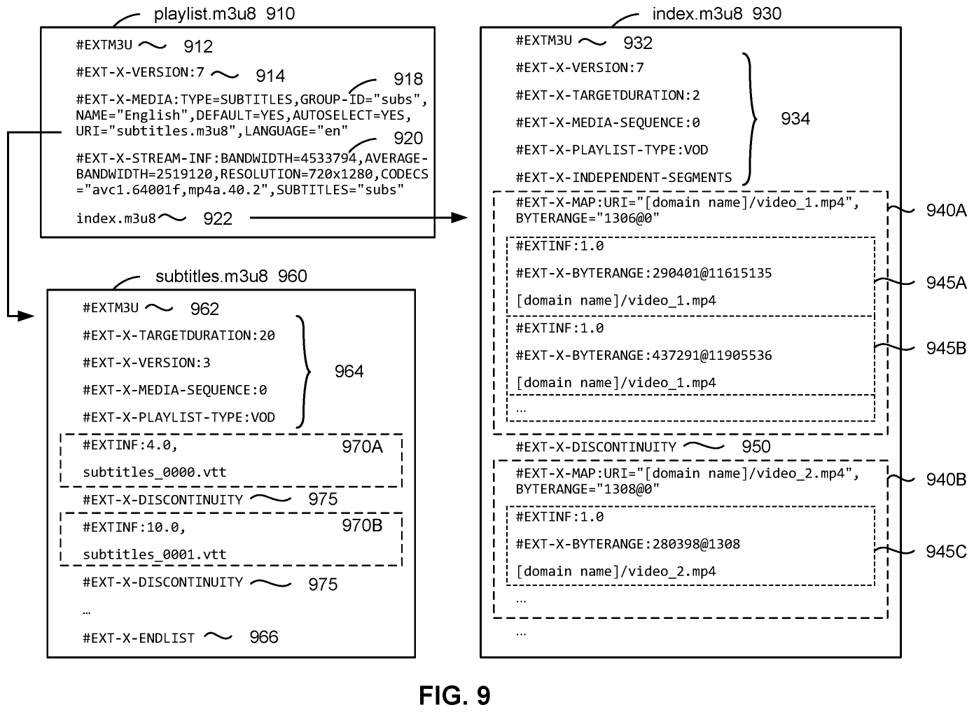

The video stitching module 745 receives multiple video snippets 130 and generates a video containing each of the received video snippets 130. In some embodiments, the video stitching module 745 generates a file (e.g., a manifest file) for instructing a media player to play each of the video snippets 130 in a predetermined order. In some embodiments, the video stitching module 745 additionally generates a file (e.g., a manifest file) combining the subtitles of each of the video snippets. An example of a set of manifest files generated for combining multiple sets of video segments, each corresponding to a search result, from multiple videos is shown in FIG. 9.

The set of files includes a master manifest file 910, and audio/video (AV) manifest file 930, and a subtitle manifest file 960. The master manifest file 910 includes a header 912, general information 914 (such as version information), a subtitle information 918 (e.g., as identified by field “#EXT-X-MEDIA:TYPE=SUBTITLES”) including a pointer to a subtitle manifest file 960, audio/video information 920 (e.g., as identified by field “#EXT-X-STREAM-INF”), and a pointer 922 to an AV manifest file 930. The subtitle information 918 may include information about a subtitle language, default options, etc. The pointer to the subtitle manifest file 960 may be in the form of a filename for the manifest file. In some embodiments, the master manifest file 910 may include subtitle information for multiple subtitles, each corresponding to a different language. The AV information 920 includes information such as video stream bandwidth, average bandwidth, video resolution, codec information, etc. The pointer 922 to the AV manifest file 930 may be in the form of a filename of the AV manifest file 930.

The subtitle manifest file 960 includes a start header 962 and an end of file 966, general information 964 (including version information, segment duration information, etc.), and pointers 970 to a set of subtitle files separated by separator 975. Each pointer 970 includes a segment duration (e.g., as specified by the field “#EXTINF”) and a filename for the subtitle file. For example, the first pointer 970 indicates that the file subtitles_0000.vtt is used for the first 4 seconds and the file subtitles_0001.vtt is used for 10 seconds thereafter. In some embodiments, each pointer 970 in the subtitle manifest file 960 corresponds to a pointer 940 in the video manifest file. That is, each pointer 970 in the subtitle manifest file 960 corresponds to a video snippet included in the search result video.

The AV manifest file 930 includes a header 932, general information 934 (including version information, segment duration information, an indication whether the video has been segmented), and pointers 940 to multiple sets of segments separated by a separator 950. For example, the AV manifest file 930 shown in FIG. 9 includes two sets of segments 940A and 940B. Each set of segments may correspond to a video snippet corresponding to a search result. As such, to combine multiple video snippets, each corresponding to a search result of a set of search results, the video stitching module 745 includes a pointer 940 for each video snippet in the AV manifest file 930. Moreover, the pointers 940 in the AV manifest file 930 are ordered based on the order determined by the sorting module 730.

Each pointer 940 corresponding to a video snippet includes initialization information for the video snippet (e.g., as specified by the field “#EXT-X-MAP”). For example, for pointer 940A corresponding to the video snippet corresponding to the first search result in a set of set results specifies the initialization information for video segment is stored in the file “video_1.mp4” at byte offset 0 for 1306 bytes. Similarly, for pointer 940B corresponding to the video snippet corresponding to the second search result in a set of set results specifies the initialization information for video segment is stored in the file “video_2.mp4” at byte offset 0 for 1308 bytes.

Moreover, each pointer 940 corresponding to a video snippet includes a set of segment pointers 945. Each segment pointer 945 in the set of segment pointers corresponds to a segment in the set of segments of the video snippet. For example, pointer 940A corresponding to the video snippet corresponding to the first search result in a set of set results includes segment pointers 945A (corresponding to the first segment of the set of segments of the video snippet corresponding to the first search result in a set of set results) and 945B (corresponding to the second segment of the set of segments of the video snippet corresponding to the first search result in a set of set results).

Each segment pointer 945 includes a segment duration (e.g., as specified by the field “#EXTINF”). In some embodiments, the segment duration is specified in a predetermined unit (e.g., second or millisecond). For example, the first segment pointer identifies a segment duration of 1 second. Each segment pointer 945 additionally includes information identifying the location for the video and audio data for the video segment. For example, segment pointer 945A specifies that the data for the first segment is stored at a byte offset of 11615135 for 290401 bytes in the file “video_1.mp4.” Similarly, segment pointer 945B specifies that the data for the first segment is stored at a byte offset of 11905536 for 437291 bytes in the file “video_1.mp4.” In this example, the second segment pointed by segment pointer 945B immediately follows the first segment pointed by segment pointer 945A (that is, the byte offset for the second segment is equal to the byte offset of the first segment plus the size of the first segment). However, this may not always be the case.

The AV manifest file 930 can be read by a media player to play the search result video. As such, the AV manifest file 930 allows a media player to play each video snippet corresponding to a set of search results. Moreover, the AV manifest file 930 allows the search module 265 to generate the search result video without having to extract data from each video file. Moreover, by expanding the search results to video snippets as described above, the search module 265 is able to generate the search result video without having to re-encode the videos included in the search result on the fly (e.g., in response to receiving the search query).

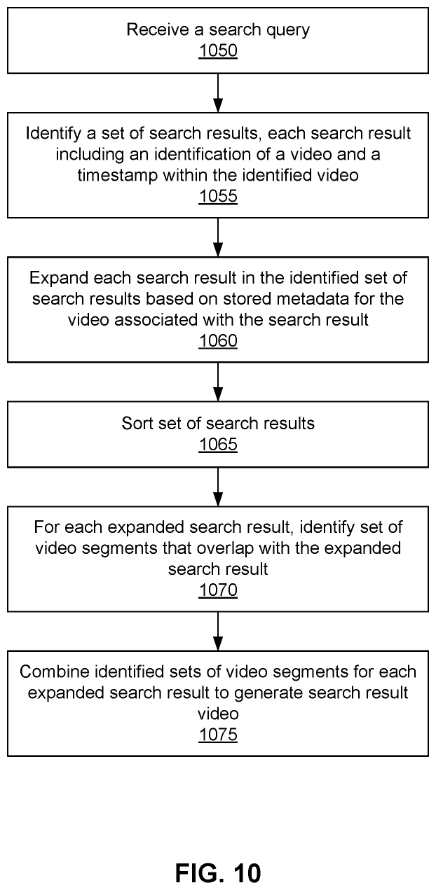

FIG. 10 is a flow diagram of a process for providing search results to a viewing user, according to one or more embodiments. The search module 260 receives 1050 a search query from a client device 210.

The filtering module 720 identifies 1055 a set of search results based on the received search query. Each search result includes an identification of a video and a timestamp and duration within the identified video. The timestamp and duration may correspond to a temporal location within the video that matches the search query.

The result expansion module 725 expands 1060 each search result included in the identified set of search results. The result expansion module 725 may expand each search result based on metadata for the video associated with the search result. To expand a search result, the result expansion module identifies a video fragment by identifying a start time and end time within the video associated with the search result based on the metadata for the video associated with the search result.

The soring module 730 sorts 1065 the set of search results and the video generation module 735 generates the search result video based on the sorted set of search results. To generate the search result video, for each search result in the set of search results, the snippet identification module 740 identifies 1070 a set of video segment that overlaps with the expanded search result. For example, for an expanded search result, the snippet identification module 740 determines a byte offset for the video segment that includes the start of the expanded search result and a length of the video snippet based on the start time and end time corresponding to the expanded search result within the video associated with the search result.

The video stitching module 745 then combines 1075 the identified sets of video segments for each expanded search result to generate the search result video. In some embodiments, the video stitching module 745 combines the identified sets of video segments by creating one or more files pointing to each of the identified video segments. For example, the video stitching module 745 generates one or more manifest files as shown in FIG. 9.

### Video Playback

The playback module 270 provides an interface to present content items to viewing users. FIG. 11 is a system environment diagram for playing a search result video, according to one or more embodiments. A search result video 150 includes snippets 130 from multiple videos 110. For instance, the search result video 150 of FIG. 11 includes snippets 130 from four different videos. The online system 240 may present the search result video 150 to a viewing user in response to a search query provided by the viewing user. The viewing user is then able to play the search result video 150. For example, the viewing user may start playback at the beginning of the search result video 150. The online system additionally allows the viewing user to access the full video 110 from which one or more snippets were extracted to generate the search result video 150.

In the example of FIG. 11, a user requests to access video 2 110B (e.g., by pressing a button while snippet B 130B is being played). In response to receiving the request to access the full video, the online system 240 stops playback of the search result video 150 and starts playback of the requested full video. In the example of FIG. 11, while the portion corresponding to snippet B 130B in the search result video 150 is being played, the user provides a request to access the full video corresponding to snippet B. As a result, the online system 240 stops playback of the search result video 150 and starts playback of video 2 110B.

In some embodiments, after the full video has finished playing, the online system resumes playback of the search result video 150. For instance, the online system 240 starts playback of the search result video 150 from the start of snippet subsequent to the snippet that was being played when the user provided the request to play the full video. That is, in the example of FIG. 11, the online system 240 may start playback from the beginning of snippet D 130D.

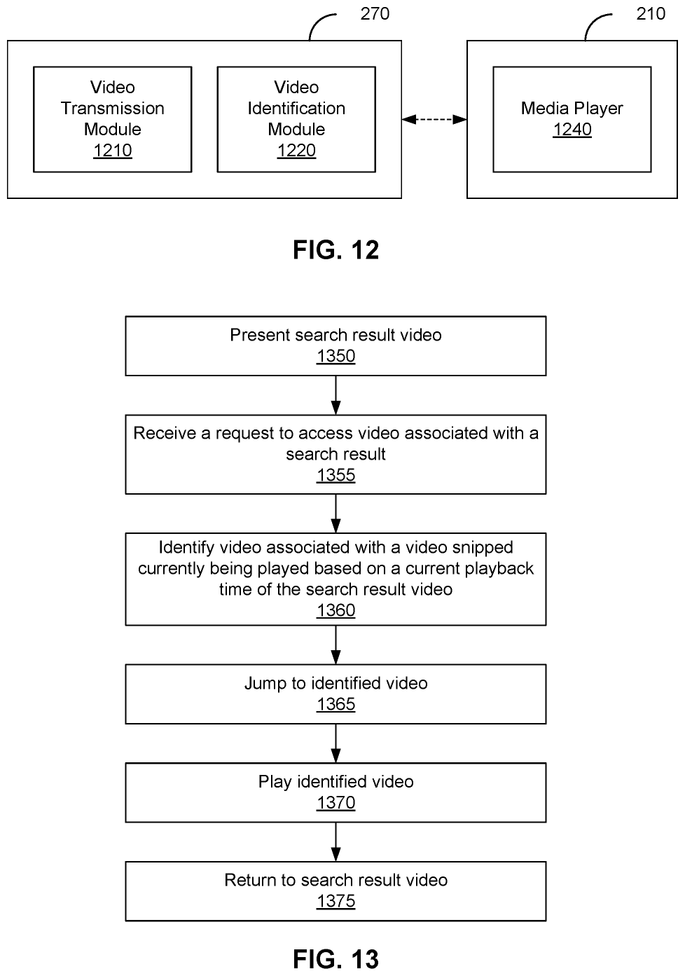

FIG. 12 is a block diagram of the components of the playback module 270, according to one or more embodiments. The playback module 270 includes a video transmission module 1210, and a video identification module 1220. The playback module 270 interacts with a media player 1240 of a client device 210 of a viewing user.

The video transmission module 1210 receives a request from the media player 1240 of the client device 210 and transmits video data to the client device 210 to allow the media player to play a video associated with the request. The video transmission module 1210 accesses the content store 255 to retrieve the video data associated with the video requested by the media player 1240.

The video identification module 1220 identifies a video associated with a request received from the client device 1240. In some embodiments, the video identification module 1220 identifies a video by a video identifier included in the request received from the client device 1240. The video identification module may have a database mapping video identifiers to storage addresses within the content store 255 where the videos are stored. Alternatively, the video identification module 1220 identifies a video based on information about a search result video being played by the media player 1240 and a playback time within the search result video that was being played when the request was sent to the playback module 270. For example, as the search result video including multiple video snippets is being played, a viewing user is given a user interface element for requesting a video associated with a video snippet being played when the user interface element is selected by the viewing user. When the user interface element is selected by the viewing user, a current playback time of the search result video is determined. Based on information about the video snippets included in the search result video and the determined playback time, a video to be played in response to the selection of the user interface element is identified.

In some embodiments, certain functions of the video identification module 1220 is performed at the client device 210. For example, the client device 210 may determine a video to be played in response to a selection of the user interface element for requesting a video associated with a video snippet being played when the user interface element is selected by the viewing user. For example, client device 210 may identify the video from the manifest file for the search result video. The manifest file includes an identification of each of the video snippets included in the search result video, and a length of each snippet. Based on the information included in the manifest file, the client device 210 identifies a video snippet that is currently being played, and requests the video associated with the identified video snippet. For instance, instead of starting the video with an offset as specified in the manifest file to play the video snippet included in the search result video, the media player requests the video without the offset to play the video associated with the video snippet from the beginning.

In some embodiments, the instructions for identifying the video are provided to the client device by the online system 240 (e.g., via the web server 290). In other embodiments, the instructions for identifying the video are coded in a native application being executed by the client device 210.

FIG. 13 is a flow diagram of a process for providing search results and playing a search result video, according to one or more embodiments. In response to a search query, the client device 210 presents 1350 a search result video to a viewing user. The search result video is compiled by the search module 265. The search result video is played by the media player 1240. In some embodiments, the media player 1240 plays the search result video based on a manifest file received from the search module 265. The media player 1240 sends requests to the video transmission module 1210 of the playback module 270 for video data the as indicated in the manifest file. The media player 1240 may send one request for each video snippet included in the search result video. Each request may include an identification of a video stored in the content store 255 and an offset corresponding to the start of the video snippet within the video. The request may additionally include a length of the snippet.

In some embodiment, the media player 1240 sequentially sends each of the requests as the search result video is played. For instance, the media player 1240 may be configured to buffer a portion of the video and send a request for a next video snippet to be played a preset amount of time before the next video snippet is expected to be played.

The video identification module 1220 receives 1355 a request to access a video associated with the search result video. The request may be received in response to the selection, by a viewing user, of a user interface element of the media player. The video identification module 1220 identifies 1360 a video associated with a video snippet from the set of video snippets included in the search result video that is currently being played by the media player 1240. The video is identified based on a current playback time of the search result video. For instance, in the example of FIG. 11, a viewing user selects the user interface element for accessing a video associated with a search result video when snippet B 130B is being played. When the user selects the user interface element, the video identification module 1220 determines that the snippet being currently played corresponds to video 2 110B. The video identification module 1220 identifies that the snippet being currently played corresponds to video 2 110B based on the playback time of the search result video 150 when the user interface element was selected by the viewing user.

The playback of the media player 1240 jumps 1365 to the identified video and starts playing 1370 the identified video. For example, after the video identification module 1220 identifies the video corresponding to the snipped being currently played, the client device 210 retrieves a manifest file for the identified video and/or video data for the identified video.

In some embodiments, when the playback of the identified video corresponding to the snippet that was being played when the user interface element was selected by the user has been completed, the media player 1240 returns to playing 1375 the search result video. For example, before jumping to the identified video, the media player 1240 may store information regarding the playback time when the user interface element was selected by viewing user. When the playback of the identified video has been completed, the media player 1240 resumes the playback of the search result video at the playback time that was being played when the user interface element was selected by viewing user.

In another example, when the playback of the identified video has been completed, the media player 1240 resumes the playback of the search result video starting at the beginning of a snippet that follows the snippet that was being played when the viewing user selected the user interface element. In yet other example, the media player 1240 skips other snippets corresponding to the same video corresponding to the snippet that was being played when the user selected the user interface element. That is, in the example of FIG. 11, the media player 1240 skips the playback of snippet B 130B and snippet C 130C corresponding to video 2 110n, and resumes playback of the search result video at the beginning of snippet D 130D corresponding to video 3 110C.

### Computing Machine Architecture

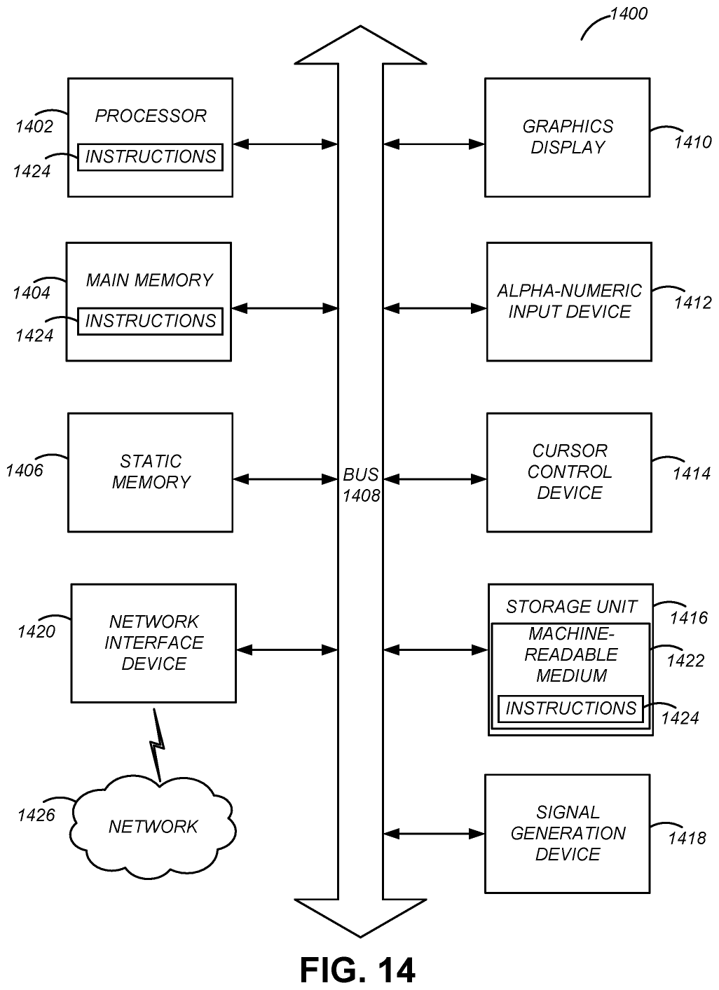

FIG. 14 is a block diagram illustrating components of an example machine able to read instructions from a machine-readable medium and execute them in a processor (or controller). Specifically, FIG. 14 shows a diagrammatic representation of a machine in the example form of a computer system 1400 within which instructions 1424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1424 (sequential or otherwise) that specify actions to be taken by that machine. Further, while only a single machine is illustrated, the term “machine” shall also be taken to include any collection of machines that individually or jointly execute instructions 1424 to perform any one or more of the methodologies discussed herein.

The example computer system 1400 includes a processor 1402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1404, and a static memory 1406, which are configured to communicate with each other via a bus 1408. The computer system 1400 may further include graphics display unit 1410 (e.g., a plasma display panel (PDP), a liquid crystal display (LCD), a projector, or a cathode ray tube (CRT)). The computer system 1400 may also include alphanumeric input device 1412 (e.g., a keyboard), a cursor control device 1414 (e.g., a mouse, a trackball, a joystick, a motion sensor, or other pointing instrument), a storage unit 1416, a signal generation device 1418 (e.g., a speaker), and a network interface device 820, which also are configured to communicate via the bus 1408.

The storage unit 1416 includes a machine-readable medium 1422 on which is stored instructions 1424 (e.g., software) embodying any one or more of the methodologies or functions described herein. The instructions 1424 (e.g., software) may also reside, completely or at least partially, within the main memory 1404 or within the processor 1402 (e.g., within a processor's cache memory) during execution thereof by the computer system 1400, the main memory 1404 and the processor 1402 also constituting machine-readable media. The instructions 1424 (e.g., software) may be transmitted or received over a network 1426 via the network interface device 1420.

While machine-readable medium 1422 is shown in an example embodiment to be a single medium, the term “machine-readable medium” should be taken to include a single medium or multiple media (e.g., a centralized or distributed database, or associated caches and servers) able to store instructions (e.g., instructions 1424). The term “machine-readable medium” shall also be taken to include any medium that is capable of storing instructions (e.g., instructions 1424) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that itis meant otherwise.

Upon reading this disclosure, those of skill in the art will appreciate still additional alternative structural and functional designs for a system and a process for video sharing platform through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving a video from a user of an online system;
extracting features from the received video;
storing the extracted features for the received video;
re-encoding the received video based on a prespecified re-encoding scheme, wherein re-encoding the received video comprises generating a set of video segments from video data of the received video, each of the video segments of the set of video segments independently playable by a media player; and
storing the re-encoded video including storing information for each of segment of the set of segments generated during the re-encoding of the received video.

2. The method of claim 1, wherein extracting features from the received video comprises generating subtitles for the video based on an audio associated with the video.

3. The method of claim 1, wherein re-encoding the received video comprises re-encoding the received video to include segments having a predetermined length.

4. The method of claim 3, wherein re-encoding the received video comprises, for each segment:
generating a key frame based on video data of the received video; and
determining data for each frame of the segment based on the generated key frame and the video data of the received video.

5. The method of claim 1, further comprising:
receiving a search query from a viewing user of the online system;
identifying a set of search results based on the received search query, each search result identifying a video and a timestamp and duration within the video;
identifying a set of video snippets, the set of video snippets including one or more video snippets for each search result of the identified set of search results; and
generating a search result video by combining the identified set of video snippets.

6. The method of claim 5, wherein the search result video is generated in real time in response to receiving the search query from the viewing user.

7. The method of claim 5, wherein the search result video is generated without re-encoding the set of search results in response to receiving the search query form the viewing user.

8. The method of claim 5, wherein the timestamp and duration within the video identified by a search result corresponds to a temporal location within the video that matches the search query.

9. The method of claim 5, wherein identifying a set of video snippets comprises, for each search result of the identified set of search results:
identifying a video fragment based on the timestamp within the video identified by the search result and metadata for the video identified by the search result; and
identifying a set of video segments of the video identified by the search result that overlaps with the identified video fragment, wherein each video segment of the set of video segments are independently playable by a media player.

10. The method of claim 9, wherein identifying a set of video segments comprises:
identifying a starting video segment that includes a beginning of the video fragment, wherein identifying the starting video segment comprises determining a byte offset for the starting video, the byte offset indicating the start of video data for the starting video segment within the video identified by the search result; and
identifying an ending video segment that includes an ending of the video fragment.

11. The method of claim 5, wherein generating a search result video by combining the identified set of video snippets comprises:
generating a manifest file, the manifest file including a pointer for each video snippet, the pointer identifying a video file associated with the video snippet and a byte offset indicating a start of video data for the video snippet within the video file.

12. The method of claim 1, further comprising:
presenting a search result video to a viewing user of an online system, the search result video including a plurality of video snippets, each video snippet corresponding to a search result for a search query provided by the viewing user;
receiving a request to access a video associated with a video snippet from the plurality of video snippets that is currently being played by a media player of a client device of the viewing user;
determining the video associated with the video snippet based on a playback time of the search result video when the request to access the video was received; and
presenting the identified video to the viewing user of the online system.

13. The method of claim 12, further comprising:
responsive to an end of a playback of the identified video, determining a restart playback time based on a playback time of the search video when the request to access the video was received; and
resuming playback of the search video at the restart playback time.

14. A computer readable medium configured to store instructions, the instructions when executed by a processor cause the processor to:
receive a video from a user of an online system;
extract features from the received video;
store the extracted features for the received video;
re-encode the received video based on a prespecified re-encoding scheme, wherein re-encoding the received video comprises generating a set of video segments from video data of the received video, each of the video segments of the set of video segments independently playable by a media player; and
store the re-encoded video including storing information for each segment of the set of segments generated during the re-encoding of the received video.

15. The computer readable medium of claim 14, further comprising instructions that cause the processor to:
receive a search query from a viewing user of the online system;
identify a set of search results based on the received search query, each search result identifying a video and a timestamp and duration within the video;
identify a set of video snippets, the set of video snippets including one or more video snippets for each search result of the identified set of search results; and
generate a search result video by combining the identified set of video snippets.

16. The computer readable medium of claim 14, further comprising instructions that cause the processor to:
present a search result video to a viewing user of an online system, the search result video including a plurality of video snippets, each video snippet corresponding to a search result for a search query provided by the viewing user;
receive a request to access a video associated with a video snippet from the plurality of video snippets that is currently being played by a media player of a client device of the viewing user;
determine the video associated with the video snippet based on a playback time of the search result video when the request to access the video was received; and
present the identified video to the viewing user of the online system.

17. An online system comprising:
a video intake module configured to receive a video from a user of the online system;
a video feature extraction module configured to extract features from a received video and store the extracted features for the received video; and
a video re-encoding module configured to:
re-encode the received video based on a prespecified re-encoding scheme, wherein re-encoding the received video comprises generating a set of video segments from video data of the received video, each of the video segments of the set of video segments independently playable by a media player, and
store the re-encoded video including storing information for each of segment of the set of segments generated during the re-encoding of the received video.

18. The online system of claim 17, further comprising:
a search module configured to:
receive a search query from a viewing user of the online system;
identify a set of search results based on the received search query, each search result identifying a video and a timestamp and duration within the video;
identify a set of video snippets, the set of video snippets including one or more video snippets for each search result of the identified set of search results; and
generate a search result video by combining the identified set of video snippets.

19. The online system of claim 17, further comprising:
a playback module configured to:
present a search result video to a viewing user of an online system, the search result video including a plurality of video snippets, each video snippet corresponding to a search result for a search query provided by the viewing user;

20. The online system of claim 19, wherein the playback module is further configured to:
receive a request to access a video associated with a video snippet from the plurality of video snippets that is currently being played by a media player of a client device of the viewing user;
determine the video associated with the video snippet based on a playback time of the search result video when the request to access the video was received; and
present the identified video to the viewing user of the online system.
